(19) United States
(12) Patent Application Publication
(10) Pub. No.: US 2015/0084848 A1
(43) Pub. Date: Mar. 26, 2015

(54) INTERACTION BETWEEN GENERIC INTERACTION DEVICES AND AN INTERACTIVE DISPLAY

(71) Applicant: BBY SOLUTIONS, INC., Richfield, MN (US)

(72) Inventor: Anshuman Sharma, Boston, MA (US)

(73) Assignee: BBY SOLUTIONS, INC., Richfield, MN (US)

(21) Appl. No.: 14/037,038

(22) Filed: Sep. 25, 2013

(51) Int. Cl. G06F 3/00

(52) U.S. Cl. CPC G06F 3/002
USPC 345/156

(57) ABSTRACT

Interaction techniques are described herein involving communications between an interactive display, an interactive system, and at least two generic interaction devices. The interactive system may process relative location information for the generic interaction devices, and the interactive system may cause the interactive display to depict interactions between generic, real-world interaction devices. This may allow for enhanced individual interaction between one or more physical generic interaction devices and a virtualized environment or a virtual world presented by the interactive display. This may also allow for other interactions between a set of generic interaction devices that can be interpreted and presented by the interactive display.

### TECHNICAL FIELD

Embodiments pertain to displaying a representation within an interactive display application of an interaction between generic interaction devices. Some embodiments relate to interactions between two or more generic interaction devices, and interpreting interactions of the device on an interactive display.

### BACKGROUND

Many existing systems incorporate an interactive display to capture human/machine interaction, with such human/machine interaction used to control or drive a displayed or virtual application. Systems range in functionality from simple objects that allow humans to interact with an interactive television/video screen display (e.g., children's interactive products made by toy manufacturers) to complex devices that allow for a user's interaction to be captured through motion capture or in association with movement of auxiliary devices (e.g., Microsoft Kinect, LeapMotion, Nintendo Wii videogame systems). However, existing systems provide limited mechanisms for real-world object-to-object interaction, and rely on a single source detection mechanism, such as video camera or IR sensors, to perceive activity and movement among humans and real world objects.

### BRIEF DESCRIPTION OF THE DRAWINGS

FIG. 1 illustrates an example interactive system, according to an example described herein.

FIG. 2 illustrates example interactive devices, according to an example described herein.

FIG. 3 illustrates a flow diagram of an example system interactive method, according to an example described herein.

FIG. 4 illustrates a flow diagram of an example master device interactive method, according to an example described herein.

FIG. 5 illustrates a block diagram of an example interactive system, including two generic interaction devices and an interactive display, according to an example described herein.

FIG. 6 is a block diagram illustrating a generic interaction device upon which any one or more of the methodologies herein discussed may be run.

### DETAILED DESCRIPTION

The following description and drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Some of the embodiments discussed herein describe an interactive display, an interactive system, and at least two generic interaction devices. The interactive system may process relative location information for the generic interaction devices, and the interactive system may cause the interactive display to depict interactions between generic interaction devices. This may allow for individual interactions between a physical generic interaction device and an interactive display. This may also allow for other interactions, between two or more generic interaction devices, to be interpreted by an interactive display.

This system may be advantageous in applications where one or more users are learning how to manipulate one or more objects. For example, such a system could be used to teach users how to manipulate medical devices, how to play musical instruments, or how to perform a ballroom dance. In some embodiments, the system could also be used to teach young children how to manipulate simple educational blocks to learn the alphabet or math, or could include basic reorganization of blocks, rings, or towers. In some embodiments, the system may also be used to teach various physical phenomena, such as the operation of radio waves, magnets, or aerodynamics. For example, movement of generic interaction devices may cause electromagnetic field lines or aerodynamic airflow lines to be displayed. In other embodiments, the relative location of generic interaction devices may be used to measure or configure the location of various physical objects. For example, generic interaction devices may be used to measure cable length required for various electronic components, to guide the placement and aiming of each speaker in a set of surround sound speakers, or to guide the placement of furniture, artwork, or electronic components in a room.

In some embodiments, a system allows a user to manipulate generic interaction devices in relation to each other to perform actions on an interactive display. The educational examples mentioned above may be used in an interactive environment. For example, a single interactive environment may be used to teach a user how to play an instrument, and then may be used in a score-based video game based on the accuracy of playing the instrument. In other embodiments, the generic interaction devices may be used to control various actions within a virtual environment. For example, the generic interaction devices may be elements of a toy gun that must be assembled before use. In other embodiments, the generic interaction devices may be used to interact with a remote user, such as in an interactive teaching or an interactive healthcare context. For example, generic interaction devices may be various simple medical devices, and a healthcare provider may remotely guide a user through an interactive physical examination.

In some embodiments, the system may supplement existing controller technology. Various existing interactive systems use line-of-sight 2-D positioning, such as the Wii's IrDA sensor or the video camera used in Xbox Kinect or PlayStation Eye. Generic interaction devices may offer non-line-of-sight input to augment such line-of-sight systems, thereby allowing a user to manipulate virtual objects without requiring a direct line-of-sight to a controller sensor, or providing for continuous movement data during periods where line-of-sight is temporarily unavailable. For example, a dance may require a user to turn his or her back to a line-of-sight controller sensor, a user may manipulate a virtual object behind his or her back, or dance or hand-to-hand combat may require movement or virtual object manipulation while another user is blocking the direct line-of-sight to a controller sensor. Generic interaction devices may also provide a depth input to augment the inherently 2-D input of line-of-sight systems. For example, an exercise or dance move may require information about relative and absolute location and motion inputs in a direction toward or away from an IrDA sensor or video camera.

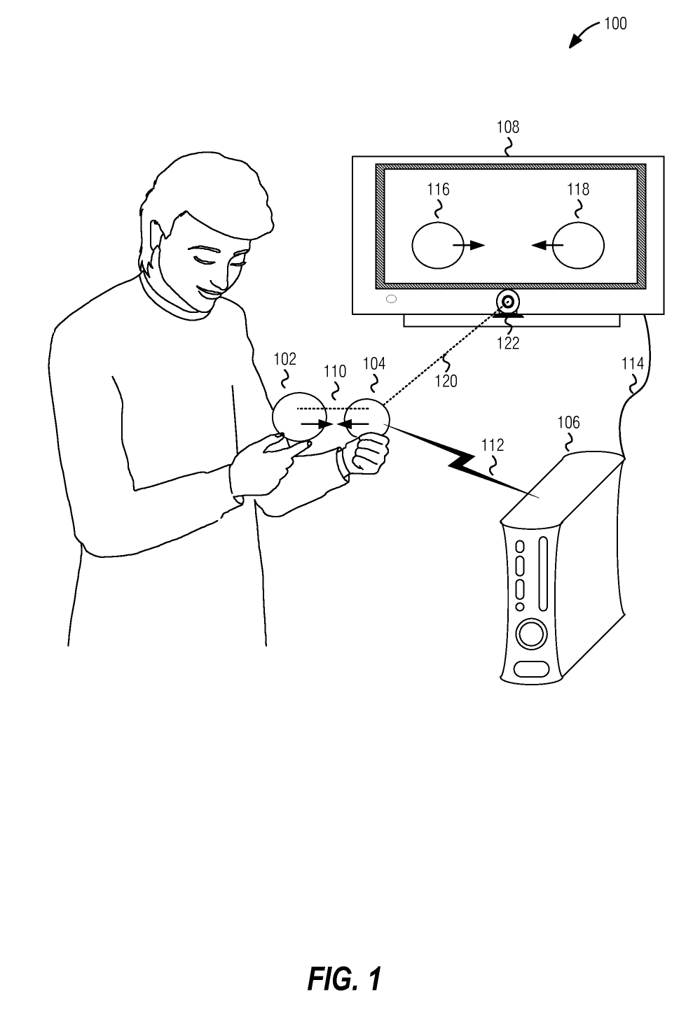

FIG. 1 illustrates an example interactive system 100, according to an example described herein. The interactive system 100 may include two generic interaction devices 102 and 104, an interactive console 106, and an interactive display 108. The generic interaction devices 102 and 104 may detect or determine information for their relative location 110 (e.g., relative distance or proximity between the objects), and may transmit 112 that relative location 110 information to the interactive console 106 (e.g., personal computer, video game system). The interactive console 106 may receive and interpret the relative location 110 information in the context of an interactive display application (e.g., video game, virtual world, or virtual reality), and may generate or transmit 114 a visual display of the interpretation of the relative location 110 information to the interactive display 108.

The interaction between the generic interaction devices 102 and 104 may be depicted on the interactive display 108 using corresponding generic interaction device virtual objects or avatars 116 and 118. For example, when the generic interaction devices 102 and 104 have been moved closer together, the generic interaction device virtual objects or avatars 116 and 118 depicted on the interactive display 108 may be moved in a corresponding direction (closer together). In another example, movement of the generic interaction devices 102 and 104 in one direction may cause the virtual objects or avatars 116 and 118 to be moved in the opposite direction. In some embodiments, the interactive console 106 and the interactive display 108 may be separate, such as a computer and computer screen or a video game system and a television. In other embodiments, the interactive console 106 and the interactive display 108 may be housed and operable within a single device, such as a tablet computer, laptop computer, input-connected dongle, smart phone, or smart TV.

The generic interaction devices 102 and 104 may include relative location detection components for detecting relative location 110 information between the respective objects. For example, the relative location detection components may detect that the generic interaction devices 102 and 104 have been moved closer together, and the relative location 110 information may reflect that increase in proximity. The generic interaction devices 102 and 104 may include passive absolute location detection components to enable the interactive console 106 to detect absolute location information. For example, the passive absolute location detection components may include infrared (IR) lights, markers, and reflectors that may be observed 120 by a camera 122. The camera 122 may be provided from the interactive display 108 (such as a camera located within a television housing), provided from the interactive console 106, or attached as a peripheral to the interactive display 108 or interactive console 106 (such as through a universal serial bus connection, an HDMI connection, a connection with a connected dongle, and the like).

The camera 122 may detect absolute location information by tracking IR light reflections among the generic interaction devices 102 and 104, by tracking the shape or color of the generic interaction devices 102 and 104, by tracking user movements of the generic interactions devices 102 and 104, or other similar mechanisms. The generic interaction devices 102 and 104 may include absolute location detection components for detecting absolute location information. For example, the absolute location detection components may include an IR camera in one or both of the generic interaction devices 102 and 104, where the IR camera is used to detect one or more external IR reference points.

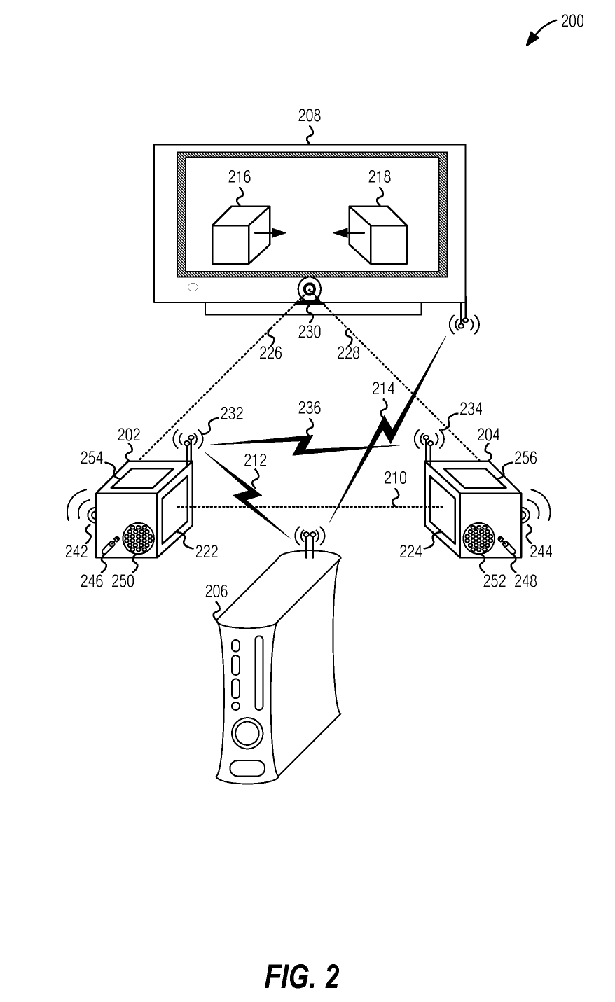

FIG. 2 illustrates example interactive devices 200 according to an example described herein. The interactive devices 200 may include two generic interaction devices configured in a primary/secondary device configuration, such as a master interaction device 202 and a slave interaction device 204 (also referred to as the generic interaction devices). The generic interaction devices 202 and 204 in FIG. 2 are shown as cubes, but may take a variety of other forms. In some embodiments, the master interaction device 202 and the slave interaction device 204 may be differentiated using a pairing function that can depend on an electronic signature (e.g., with identifiers exchanged using RFID or NFC tags). These generic interaction devices 202 and 204 may use capacitive touch points to identify an anchor point (e.g., an initial starting location), and the orientation of the touch points could be used to distinguish between the two generic interaction devices 202 and 204. Once the generic interaction devices 202 and 204 have been paired with a system or otherwise detected within a system, one or both of the generic interaction devices 202 and 204 may be used to manipulate one or more virtual objects in the context of an application. For example, manipulating the generic interaction devices 202 and 204 for a character-based action game application may cause various character movements, or manipulating the generic interaction devices 202 and 204 for a puzzle game application may cause movement of puzzle pieces.

In one embodiment, the master interaction device 202 includes hardware or software functionality not included in the slave interaction device 204. For example, the master interaction device 202 may include active location detection hardware, and the slave interaction device 204 may include passive location detection hardware. In other embodiments, the master interaction device 202 and a slave interaction device 204 may include identical hardware (e.g., components), but may perform different functions or roles. For example, the master interaction device 202 and the slave interaction device 204 may both include communications hardware, and after one of the interaction devices is designated as the master interaction device 202, that device may perform all communication with an interactive console 206 (e.g., personal computer, video game system) or an interactive display 208.

The generic interaction devices 202 and 204 may wirelessly detect or determine information regarding their relative location 210, and the master interaction device 202 may transmit 212 that relative location information 210 to the interactive console 206. The interactive console 206 may receive and interpret the relative location information 210 in the context of an interactive display application and transmit 214 a visual display of the interpretation of the relative location information 210 to the interactive display 208. The interaction between the generic interaction devices 202 and 204 may be depicted on the interactive display 208 using corresponding generic interaction device virtual objects or avatars 216 and 218. For example, the generic interaction devices 202 and 204 may detect that they have been moved closer together, and the relative location information 210 may reflect that increase in proximity.

The generic interaction devices 202 and 204 may detect or determine information regarding their relative location 210 using one or a combination of active or passive relative location detection components 222 and 224. The relative location detection components 222 and 224 may actively send and receive information to and from each other to detect relative location information 210, such as using a received signal strength indicator (RSSI) in Bluetooth or other measurements available with operations of RF protocols. The first relative location detection component 222 may include a passive device, such as an RFID chip, and the second relative location detection component 224 may actively detect the proximity of the RFID chip. The relative location detection components 222 and 224 may include a combination of active and passive components, and may switch between using active or passive components to conserve power, to increase accuracy, or to improve system performance. The relative location detection components 222 and 224 may use sonic or optical ranging, or may use sonic or optical communication for ranging (e.g., IrDA communication). The relative location detection components 222 and 224 may include inertial sensors (e.g., accelerometers, gyroscopes) to detect acceleration, rotation, or orientation information relative to gravity. Other non-proximity information from these components may be used for feedback, processing, or changes either at the generic interaction devices 202 and 204 or in the interactive display 208. Further, the generic interaction devices 202 and 204 may discern location and orientation information with respect to each other through a localization scheme enabled through user interaction or automated processing with the interactive display 208.

In addition to the relative location detection components 222 and 224, the generic interaction devices 202 and 204 may include passive or active absolute location detection components. For example, a camera 230 may observe an IR light on each of the generic interaction devices 202 and 204 and detect 226 the absolute location of the master interaction device 202 and detect 228 the absolute location of the slave interaction device 204.

The generic interaction devices 202 and 204 may include interactive communication components 232 and 234. The interactive communication components 232 and 234 may be RF components (e.g., Bluetooth, ANT, ZigBee, or Wi-Fi). The interactive communication components 232 and 234 may be external to the generic interaction devices 202 and 204, such as is depicted in FIG. 2, or the interactive communication components 232 and 234 may be internal to the generic interaction devices 202 and 204. The interactive communication components 232 and 234 may be used to communicate 236 relative location 210 information or sensor information between the generic interaction devices 202 and 204. For example, the slave interaction device 204 may communicate 236 relative location 210 information to the master interaction device 202, and the master interaction device 202 may transmit 212 that relative location 210 information to the interactive console 206. The interactive communication components 232 and 234 may also be used in detecting relative location 210 information.

In some embodiments, in addition to causing an action on the interactive display 208, the generic interaction devices 202 and 204 may interact with each other. The generic interaction devices 202 and 204 may include sensory feedback components that may indicate when the two generic interaction devices 202 and 204 have been arranged or are being manipulated in a specific manner. The sensory feedback components may include lights 242 and 244, vibration components 246 and 248, speakers 250 and 252, or other electromagnetic or electromechanical components. The sensory feedback components may provide a binary feedback, where the light, sound, or vibration is either on or off. For example, a toy gun may include a light or simulated clicking sound to indicate a toy gun ammo clip has been correctly inserted, two cubes may vibrate briefly to indicate they have been placed together in the correct orientation, or user-worn generic interaction devices may vibrate briefly upon performing a dance move correctly. The sensory feedback components may provide varying levels of feedback, where the light, sound, or vibration may be increased or decreased in intensity. For example, the intensity of the light, sound, or vibration may increase as the user moves the generic interaction devices 202 and 204 in a desired direction. The sensory feedback components may also alter the motion of the generic interaction devices 202 and 204. For example, a solenoid may shift the balance of the master interaction device 202 to indicate that the user is manipulating it incorrectly. In another example, based on the orientation or proximity of two cubes, the generic interaction devices 202 and 204 may activate an electromagnetic component to attract one another to indicate that the user is manipulating the generic interaction devices 202 and 204 correctly.

The generic interaction devices 202 and 204 may include input components 254 and 256. The input components 254 and 256 may receive touch-sensitive input (e.g., computer trackpad, capacitive touchscreen, resistive touchscreen), which may enable touchscreen inputs such as swiping, pinching, or expanding. The input components 254 and 256 may receive conventional controller input, such as from a keyboard, interactive environment buttons, joystick input, or optical mouse input. The input components 254 and 256 may receive other inputs, such as an environmental readings (e.g., temperature, atmospheric pressure) or mechanical readings (e.g., compression or distortion of the generic interaction device). The input components 254 and 256 may be used in the absolute positioning of the generic interaction devices 202 and 204, such externally provided ranging information or input video of external reference points. Each of these input components may be used separately or in combination to cause interaction between the virtual objects on the interactive display. For example, a touch sensitive input in combination with the repositioning of the generic interaction devices 202 and 204 may change the virtual object(s) differently than a simple repositioning of the generic interaction devices 202 and 204. The input components may also provide inputs used to change the shape, geometry, or other visible properties of any displayed virtual objects on the interactive display.

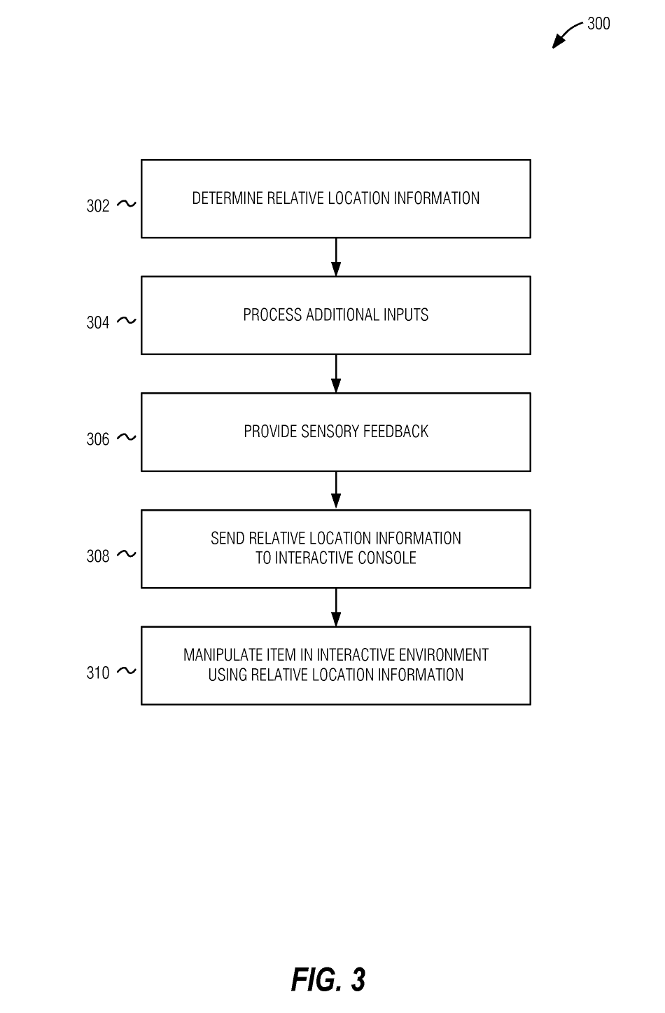

FIG. 3 illustrates an example system interactive method 300, according to an example described herein. The system interactive method 300 may begin by determining the relative location information (operation 302), such as between two generic interaction devices 102 and 104 pictured in FIG. 1. The detection of relative location information (e.g., 110 or 210) may include using passive or active technologies to detect or compare proximity, velocity, acceleration, or orientation of the generic interaction devices (e.g., 102, 104 or 202, 204). The system interactive method 300 may process additional inputs (operation 304) to augment the relative location information (e.g., 110 or 210). For example, additional inputs may include conventional controller inputs, touch-sensitive input, environmental or mechanical readings, or input to provide for absolute positioning of the generic interaction devices (e.g., 102, 104 or 202, 204). The system interactive method 300 may use the relative location information (e.g., 110 or 210) or the additional inputs to provide sensory feedback (operation 306). Providing sensory feedback 306 may include manipulating lights, speakers, vibration components, electromagnetic components, or electromechanical components to indicate when the generic interaction devices (e.g., 102, 104 or 202, 204) have been arranged or are being manipulated in a specific manner.

Once the relative location information (e.g., 110 or 210) has been detected (operation 302), the system interactive method 300 may send the relative location information (e.g., 110 or 210) to an interactive console (e.g., the interactive console 206 of FIG. 2) (operation 308). Using the received location information (e.g., 110 or 210), the system interactive method 300 may manipulate items in the interactive environment using the relative location information (e.g., 110 or 210) (operation 310). For example, manipulation of generic interaction devices (e.g., 102, 104 or 202, 204) may cause a similar manipulation of virtual objects.

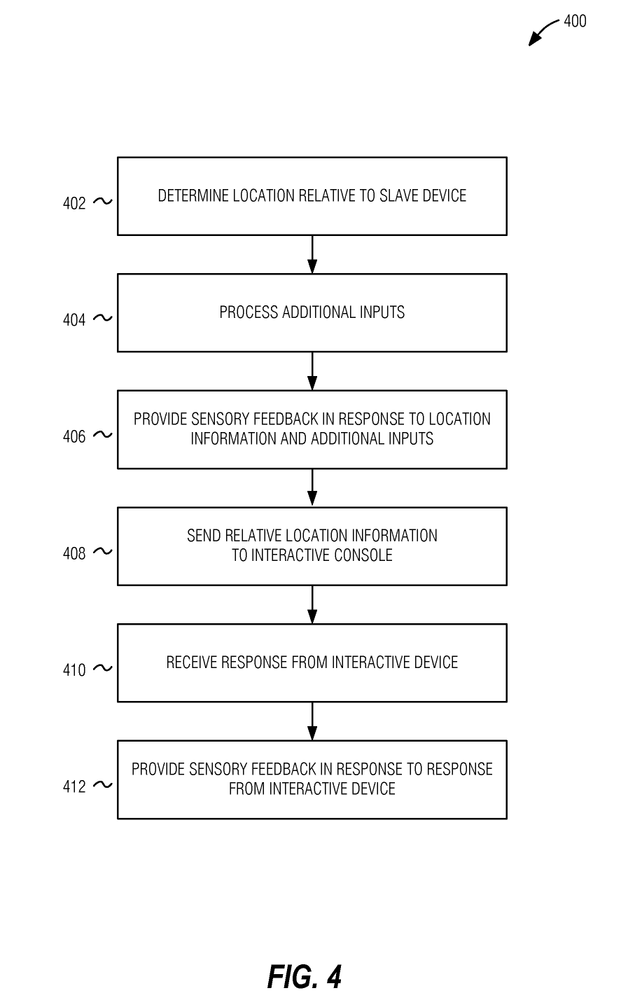

FIG. 4 illustrates an example master device interactive method 400, according to an example described herein. The master device interactive method 400 may be implemented in hardware or software within the master device. The master device interactive method 400 may detect the location of a master device (e.g., 102 or 202) relative to a slave device (e.g., 104 or 204) (operation 402). The detection of relative location information (e.g., 110 or 210) (operation 402) may include using passive or active technologies to detect proximity, velocity, acceleration, or orientation of the master device relative to the slave device. The master device interactive method 400 may process additional inputs (operation 404) to augment the relative location information (e.g., 110 or 210). For example, additional inputs may include conventional controller inputs, touch-sensitive input, environmental or mechanical readings, or input to provide for absolute positioning of the generic interaction devices (e.g., 102, 104 or 202, 204). The master device interactive method 400 may use the relative location information (e.g., 110 or 210) or the additional inputs to provide sensory feedback in response to location information and additional inputs (operation 406). Providing sensory feedback (operation 406) may include providing sensory feedback within the master device or instructing the slave device to provide sensory feedback, where the slave device sensory feedback may be different from the master device sensory feedback. Providing sensory feedback (operation 406) may include manipulating lights, speakers, vibration components, or electromagnetic or electromechanical components to indicate when the generic interaction devices (e.g., 102, 104 or 202, 204) have been arranged or are being manipulated in a specific manner.

The master device interactive method 400 may send the relative location information (e.g., 110 or 210) to an interactive console (e.g., 206) (operation 408). The master device interactive method 400 may then receive a response from the interactive device (e.g., 206) (operation 410), where the response is based on the relative location information (e.g., 110 or 210). Using the response from the interactive device (e.g., 206), the master device interactive method 400 may provide sensory feedback to the generic interaction devices (e.g., 102, 104 or 202, 204) (operation 412).

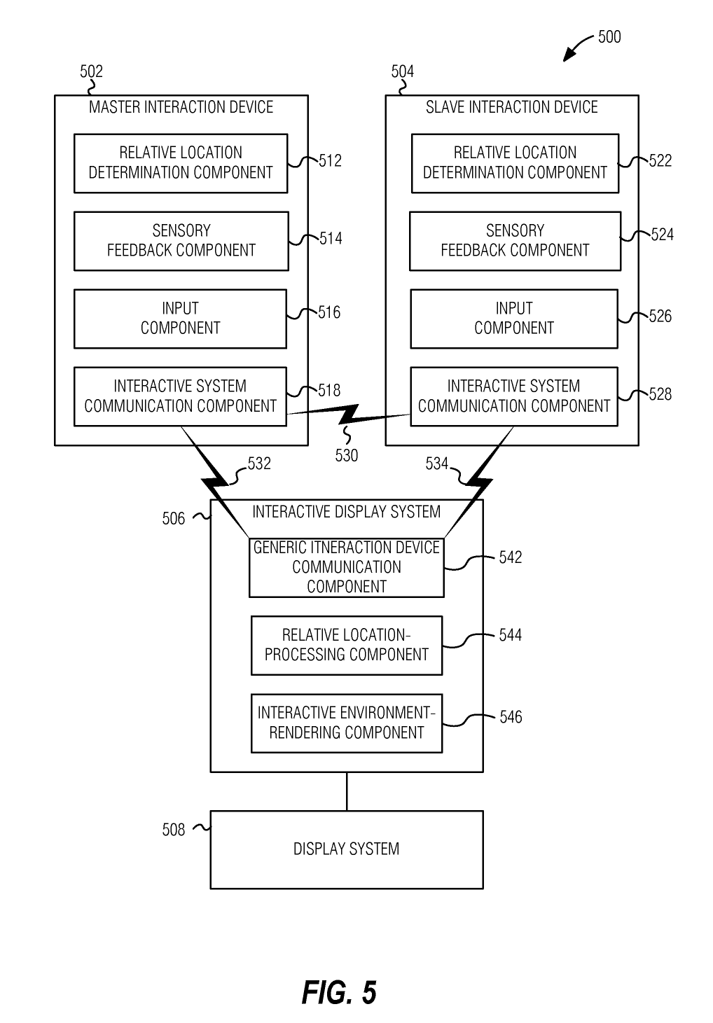

FIG. 5 illustrates a block diagram of an example interactive system 500 including two generic interaction devices and an interactive display, according to an example described herein. The example interactive system 500 may include a master interaction device 502, a slave interaction device 504, an interactive display system 506, and a display system 508. Though FIG. 5 depicts the master and slave interaction devices 502 and 504 as including identical components (e.g., hardware, software, and firmware), the master and slave interaction devices 502 and 504 may include different components in various embodiments.

The master interaction device 502 may include a master relative location determination component 512, and the slave interaction device 504 may include a slave relative location determination component 522. The relative location determination components 512 and 522 may interact with each other to detect relative location information, or may operate independently to detect relative location information. The relative location determination components 512 and 522 may actively send and receive information to and from each other to detect relative location information, such as using a received signal strength indicator (RSSI) in Bluetooth or other RF protocol. The master relative location determination component 512 may include a passive device, such as an RFID chip, and the slave relative location determination component 522 may actively detect the proximity of the RFID chip. The relative location determination components 512 and 522 may include a combination of active and passive components, and may switch between using active or passive components to conserve power, to increase accuracy, or to improve system performance. The relative location determination components 512 and 522 may use sonic or optical ranging, or may use sonic or optical communication for ranging (e.g., IrDA communication). The relative location determination components 512 and 522 may include inertial sensors (e.g., accelerometers, gyroscopes) to detect acceleration, rotation, or orientation information relative to gravity.

The master interaction device 502 may include a master sensory feedback component 514, and the slave interaction device 504 may include a slave sensory feedback component 524. These sensory feedback components 514 and 524 may include various feedback implementations, such as lights, speakers, vibration components, or electromagnetic components to indicate when the generic interaction devices 502 and 504 have been arranged or are being manipulated in a specific manner. The sensory feedback components 514 and 524 may provide a binary feedback, where the light, sound, or vibration is either on or off. The sensory feedback components 514 and 524 may provide varying levels of feedback, where the light, sound, or vibration may be increased or decreased in intensity. The sensory feedback components 514 and 524 may include electromagnetic or other motion-based feedback, such as a solenoid that shifts the balance of the generic interaction devices 502 and 504, or an electromagnet that causes the generic interaction devices 502 and 504 to repulse or attract one another.

The master interaction device 502 may include a master input component 516, and the slave interaction device 504 may include a slave input component 526. The master and slave input components 516 and 526 may receive input from external sources, or may include various components to measure or observe external information. The master and slave input components 516 and 526 may receive conventional controller input, such as from a keyboard, interactive environment buttons, joystick input, or optical mouse input. The master and slave input components 516 and 526 may receive touch-sensitive input (e.g., computer trackpad, capacitive touchscreen, resistive touchscreen), which may enable touchscreen inputs such as swiping, pinching, or expanding. The master and slave input components 516 and 526 may receive other inputs, such as an environmental readings (e.g., temperature, atmospheric pressure) or mechanical readings (e.g., compression or distortion of the generic interaction devices 502 and 504). The master and slave input components 516 and 526 may receive other input to provide for absolute positioning of the master and slave interaction devices 502 and 504, such as externally provided ranging information or input video of external reference points. For example, an external device may provide a distance-sensitive RF beacon, or an infrared (IR) light might provide an external reference point to indicate the direction of the display.

The master interaction device 502 may include a master interactive system communication component 518, and the slave interaction device 504 may include a slave interactive system communication component 528. The interactive system communication components 518 and 528 may communicate directly with each other 530, or may communicate 532 and 534 with a generic interaction device communication component 542 within the interactive display system 506. Though FIG. 5 depicts interactive system communication components 518 and 528 within the master and slave interaction devices 502 and 504, a different arrangement of components may be used. For example, the master interaction device 502 may include only a relative location determination component 512, the slave interaction device 504 may include all other components, and all generic interaction device information may be communicated 534 through the slave interactive system communication component 528 to the generic interaction device communication component 542.

The generic interaction device communication component 542 may be external to the interactive display system 506, such as is depicted in FIG. 1, or the generic interaction device communication component 542 may be internal to the interactive display system 506. The interactive display system 506 may also include a relative location-processing component 544, which may interpret the relative location information in the context of an interactive display application. For example, moving the master interaction device 502 closer to the slave interaction device 504 may cause two virtual objects in the interactive display application to move closer together. Once the relative location has been processed, an interactive environment-rendering component 546 may generate an updated display of the interactive display application and send the display to a display system 508, where the updated display reflects the effect of the change in relative location of the master and slave interaction devices 502 and 504.

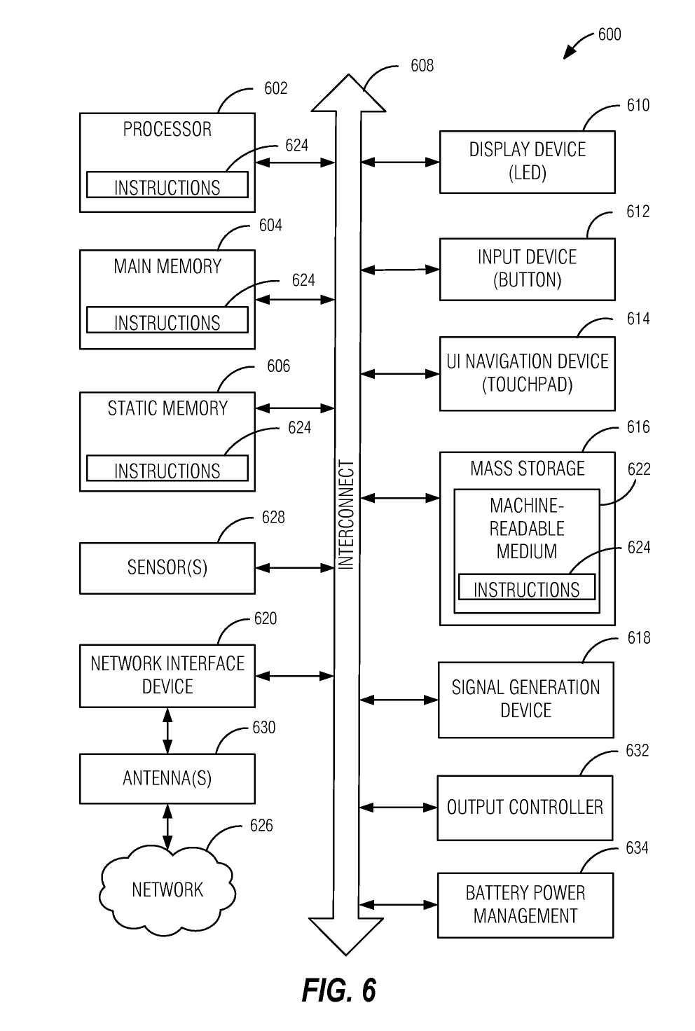

FIG. 6 is a block diagram illustrating a generic interaction device 600 upon which any one or more of the methodologies herein discussed may be run. In alternative embodiments, the generic interaction device 600 operates as a standalone device or may be connected (e.g., networked) to other devices. In a networked deployment, the generic interaction device 600 may operate in the capacity of either a server or a client device in server-client network environments, or it may act as a peer device in peer-to-peer (or distributed) network environments. The generic interaction device 600 may be a simple device that includes a portable personal computer (PC) (e.g., a notebook or a netbook), a tablet, an interactive console, a Personal Digital Assistant (PDA), a mobile telephone or smartphone, a web appliance, a network router, switch or bridge, or any device capable of executing instructions 624 (sequential or otherwise) that specify actions to be taken by that generic interaction device 600. Further, while only a single device is illustrated, the term “device” shall also be taken to include any collection of devices that, individually or jointly, execute a set (or multiple sets) of instructions 624 to perform any one or more of the methodologies discussed herein.

The example generic interaction device 600 includes a processor 602 (e.g., a central processing unit (CPU), a graphics processing unit (GPU) or both), a main memory 604 and a static memory 606, which communicate with each other via an interconnect 608 (e.g., a link, a bus, etc.). The generic interaction device 600 may further include a display device 610 to provide visual feedback, such as one or more LED lights or an LCD display. The generic interaction device 600 may further include an input device 612 (e.g., a button or alphanumeric keyboard), and a user interface (UI) navigation device 614 (e.g., an integrated touchpad). In one embodiment, the display device 610, input device 612 and UI navigation device 614 are a touch screen display. The generic interaction device 600 may additionally include mass storage 616 (e.g., a drive unit), a signal generation device 618 (e.g., a speaker), an output controller 632, battery power management 634, and a network interface device 620 (which may include or operably communicate with one or more antennas 630, transceivers, or other wireless communications hardware), and one or more sensors 628, such as a GPS sensor, compass, location sensor, accelerometer, or other sensor.

The mass storage 616 includes a machine-readable medium 622 on which is stored one or more sets of data structures and instructions 624 (e.g., software) embodying or utilized by any one or more of the methodologies or functions described herein. The instructions 624 may also reside, completely or at least partially, within the main memory 604, static memory 606, and/or within the processor 602 during execution thereof by the generic interaction device 600, with the main memory 604, static memory 606, and the processor 602 constituting machine-readable media.

While the machine-readable medium 622 is illustrated in an example embodiment to be a single medium, the term “machine-readable medium” may include a single medium or multiple media (e.g., a centralized or distributed database, and/or associated caches and servers) that store the one or more instructions 624. The term “machine-readable medium” shall also be taken to include any tangible medium that is capable of storing, encoding or carrying instructions 624 for execution by the generic interaction device 600 and that cause the generic interaction device to perform any one or more of the methodologies of the present disclosure or that is capable of storing, encoding or carrying data structures utilized by or associated with such instructions 624. The term “machine-readable medium” shall, accordingly, be taken to include, but not be limited to, solid-state memories, optical media, and magnetic media. Specific examples of machine-readable media 622 include non-volatile memory, including, by way of example, semiconductor memory devices (e.g., Electrically Programmable Read-Only Memory (EPROM), Electrically Erasable Programmable Read-Only Memory (EEPROM)) and flash memory devices; magnetic disks such as internal hard disks and removable disks; magneto-optical disks; and CD-ROM and DVD-ROM disks.

The instructions 624 may further be transmitted or received over a communications network 626 using a transmission medium via the network interface device 620 utilizing any one of a number of well-known transfer protocols (e.g., HTTP). Examples of communication networks 626 include a local area network (LAN), wide area network (WAN), the Internet, mobile telephone networks, Plain Old Telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions 624 for execution by the generic interaction device 600, and includes digital or analog communications signals or other intangible medium to facilitate communication of such software.

Embodiments may be implemented in connection with wired and wireless networks, across a variety of digital and analog mediums. Although some of the previously described techniques and configurations were provided with reference to implementations of consumer electronic devices with wired or physically coupled digital signal connections, these techniques and configurations may also be applicable to display of content from wireless digital sources from a variety of local area wireless multimedia networks and network content accesses using WLANs, WWANs, and wireless communication standards. Further, the previously described techniques and configurations are not limited to input sources provided from a direct analog or digital signal, but may be applied or used with any number of multimedia streaming applications and protocols to provide display content over an input link.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a device (e.g., a computer or other processor-driven display device). For example, a machine-readable storage device may include read-only memory (ROM), random-access memory (RAM), magnetic disk storage media, optical storage media, flash-memory devices, and other storage devices and media. In some embodiments, display devices such as televisions, A/V receivers, set-top boxes, and media players may include one or more processors and may be configured with instructions stored on such machine-readable storage devices.

What is claimed is:

1. An interaction device comprising:
a location detection component configured for detecting relative location information, wherein the relative location information includes an interaction device location relative to a second interaction device; and
a location communication component configured for wirelessly transmitting the relative location information to an interactive display, wherein the interactive display modifies a virtual object within a virtual environment based on the relative location information.

2. The device of claim 1, wherein the location detection component detects when the interaction device is within a predetermined distance of the second interaction device.

3. The device of claim 1, wherein the location detection component detects whether a distance between the interaction device and the second interaction device is constant, increasing, or decreasing.

4. The device of claim 1, wherein the location detection component detects acceleration or orientation of at least one of the interaction device or the second interaction device.

5. The device of claim 1, wherein the location detection component includes an active relative location detection component.

6. The device of claim 5, wherein the active relative location detection component includes a radio frequency identification (RFID) reader, or a Near Field Communication (NFC) device.

7. The device of claim 5, wherein the active relative location detection component includes an active RF-based relative location detection component.

8. The device of claim 7, wherein the active RF-based relative location detection component includes hardware operating according to a Bluetooth, ANT, ZigBee, or Wi-Fi wireless network protocol.

9. The device of claim 1, wherein the interaction device detects absolute relative location information of the interaction device relative to the interactive display.

10. The device of claim 1, comprising an external input component, wherein the external input component is configured to detect conventional controller inputs, touch-sensitive input, environmental readings, mechanical readings, or input to provide for absolute positioning of the interaction device.

11. The device of claim 1, comprising a sensory feedback component.

12. The device of claim 11, wherein the sensory feedback component includes a light, a speaker, a vibration component, an electromagnetic component, or an electromechanical component.

13. A method performed by an interaction device comprising:
detecting relative location information for the interaction device relative to a second interaction device; and
transmitting the relative location information from the interaction device to an interactive display.

14. The method of claim 13, wherein detecting relative location information includes detecting proximity information, acceleration information, or orientation information.

15. The method of claim 13, comprising processing additional inputs.

16. The method of claim 15, wherein processing additional inputs includes processing controller input, touch-sensitive input, environmental or mechanical readings, or input to provide for absolute positioning of the interaction device or the second interaction device.

17. The method of claim 13, comprising generating a first sensory feedback.

18. The method of claim 17, wherein generating the first sensory feedback includes causing the interaction device to generate light, sound, vibration, or movement.

19. The method of claim 13, comprising:
receiving feedback instructions from the interactive display; and
providing, in response to receiving feedback instructions from the interactive display, a second sensory feedback.

20. A system comprising:
a master interaction device and a slave interaction device configured to detect and transmit relative location information; and
an interactive device, the interactive device including:
a component configured to receive relative location information;
a processor; and
a memory including instructions, which when executed by the processor, cause the processor to manipulate at least one virtual object in an interactive environment.

21. The system of claim 20, wherein the master and slave interaction devices are further configured to receive external input wherein the external input includes input from a conventional controller, touch-sensitive input, environmental or mechanical readings, or input to provide for absolute positioning of the master and slave interaction devices.

22. The system of claim 20, wherein the master and slave interaction devices provide sensory feedback, wherein the sensory feedback includes at least one of a light, a speaker, a vibration component, an electromagnetic component, or an electromechanical component.
